(19) United States
(12) Patent Application Publication
(10) Pub. No.: US 2015/0005905 A1
(43) Pub. Date: Jan. 1, 2015

(54) PROGRAMMABLE CONTROL APPARATUS, METHOD, AND PROGRAM

(71) Applicant: KABUSHIKI KAISHA TOSHIBA, Minato-ku, Tokyo (JP)

(72) Inventors: Toshifumi Hayashi, Yokohama-Shi (JP); Atsushi Kojima, Nishitokyo-Shi (JP); Hirotaka Sakai, Machida-Shi (JP); Mamoru Kato, Yokohama Shi (JP); Yoshiyuki Nitta, Inagi Shi (JP); Yukitaka Yoshida, Fuchu-Shi (JP); Susumu Yoshizawa, Fuchu-shi (JP); Yoshito Sameda, Yokohama-shi (JP)

(73) Assignee: KABUSHIKI KAISHA TOSHIBA, Minato-Ku, Tokyo (JP)

(21) Appl. No.: 14/368,026

(22) PCT Filed: Dec. 21, 2012
(86) PCT No.: PCT/JP2012/083339

§ 371 Date: Jun. 23, 2014

(30) Foreign Application Priority Data
Dec. 23, 2011 (JP) 2011-282446

(51) Int. Cl. G05B 19/042

(52) U.S. Cl. CPC G05B 19/042; G05B 2219/23214
USPC 700/81

(57) ABSTRACT

Provided is a programmable control apparatus for performing a self-diagnosis process using a short-period single loop. The programmable control apparatus includes: a signal processing unit configured to sequentially process inputted external signals based on a program in a memory; a data acquisition unit configured to acquire data from a specified nth block of a plurality of blocks obtained by dividing an area of the memory; a diagnostic unit configured to diagnose health of the nth block based on the acquired data and then prompt a next external signal to be processed; and a block specification unit configured to cause health of an (n+1)th block to be diagnosed after the next external signal is processed.

### TECHNICAL FIELD

The present invention relates to a programmable control technique for processing inputted external signals based on a program in memory.

### BACKGROUND ART

Safety protection systems are installed in a nuclear power plant, including a reactor protection system designed to automatically start an emergency shutdown system of a reactor in case of abnormal conditions and an engineered safety features actuation system designed to automatically start a core injection system in case of coolant loss.

Many of the safety protection systems in nuclear power plants are made up of a programmable control apparatus which uses a CPU. The programmable control apparatus performs a program based process by accepting input of pressure, temperature, and other process signals (external signals) and determines whether to output a control signal to automatically start the emergency shutdown system or core injection system described above.

The programmable control apparatus for the safety protection system in a nuclear power plant is basically the same in functionality and configuration as those for general industrial use, but is required of very high reliability. For this reason, the programmable control apparatus for this application is expected to demonstrate that health of operation is maintained, and a programmable control apparatus which performs a self-diagnosis process to check for failures is used (e.g., Patent Document 1).

### PRIOR ART DOCUMENTS

### Patent Documents

Patent Document 1: Japanese Patent Laid-Open No. 2006-40122

### SUMMARY OF THE INVENTION

### Problems to be Solved by the Invention

On the other hand, many of programmable control apparatus for industrial use support multitasking, and a program which implements multitasking uses a timer interrupt for task-switching. Because the task-switching by the timer interrupt involves complex processes, it is not easy to demonstrate that the processes always work as expected, and the health of operation could be impaired.

Thus, consideration is given to performing all processes using a single loop by giving up multitasking which inevitably involves interrupt handling. However, if a self-diagnosis process is incorporated into a single loop, there is a problem in that a loop period will get longer. Diagnostic time can be reduced if a high-performance CPU is used, but the high-performance CPU will produce a lot of heat, degrading reliability of components.

The present invention has been made in view of the above problem and has an object to provide a programmable control technique for performing a self-diagnosis process using a short-period single loop.

### BRIEF DESCRIPTION OF THE DRAWINGS

FIG. 1 is a mechanical configuration diagram of an embodiment of a programmable control apparatus according to the present invention.

FIG. 2 is a configuration diagram of a memory (RAM) installed on a programmable control apparatus in each embodiment.

FIG. 3 is a logical configuration diagram of a CPU installed on a programmable control apparatus according to a first embodiment.

FIG. 4 is a flowchart illustrating operation of the programmable control apparatus according to the first embodiment.

FIG. 5 is a logical configuration diagram of a CPU installed on a programmable control apparatus according to a second embodiment.

FIG. 6 is a flowchart illustrating operation of the programmable control apparatus according to the second embodiment.

FIG. 7 is a flowchart illustrating operation of a programmable control apparatus according to a third embodiment.

### DESCRIPTION OF EMBODIMENTS

### First Embodiment

Embodiments of the present invention will be described below with reference to the accompanying drawings.

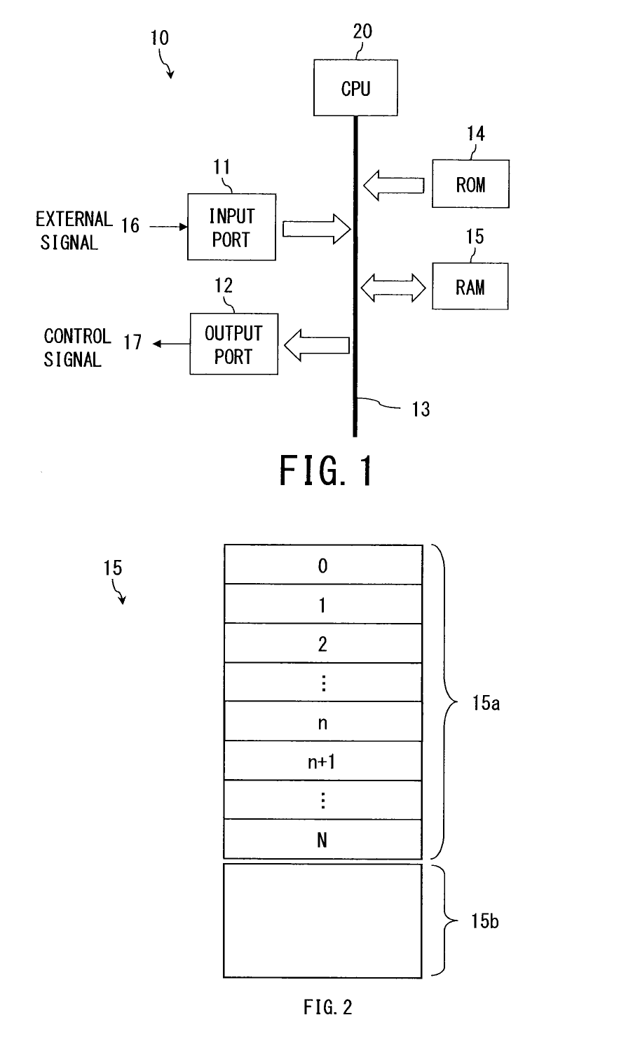

As shown in FIG. 1, a programmable control apparatus 10 according to a first embodiment includes an input port 11 adapted to receive a process signal (external signal 16) measured by a sensor (not shown) installed in a plant, an output port 12 adapted to send a control signal 17 such as a trip signal for bringing a reactor to an emergency shutdown or a start signal for engineered safety features, a CPU 20 adapted to process the received external signal 16 and determine whether or not the control signal 17 are to be sent, a ROM 14 which is a nonvolatile memory adapted to store programs and parameters used to operate the programmable control apparatus 10, a RAM (memory 15) into which the programs and parameters stored in the ROM 14 are copied on startup of the programmable control apparatus 10, and a bus 13 adapted to allow data to be transmitted among the input port 11, output port 12, ROM 14, RAM (memory 15), and CPU 20.

As shown in FIG. 2, the memory 15 (RAM) installed on the programmable control apparatus 10 in each embodiment is made up of a fixed data storage area 15a and a variable data storage area 15b, where the fixed data storage area 15a stores system programs, applications programs, parameters, and the like whose data content remains unchanged after startup of the apparatus and the variable data storage area 15b stores data on a process based on the external signals 16, data on a self diagnosis process, and the like with data content being changed after startup.

The programmable control apparatus 10 according to the first embodiment mainly performs health diagnostics of the fixed data storage area 15a of the memory 15 (RAM).

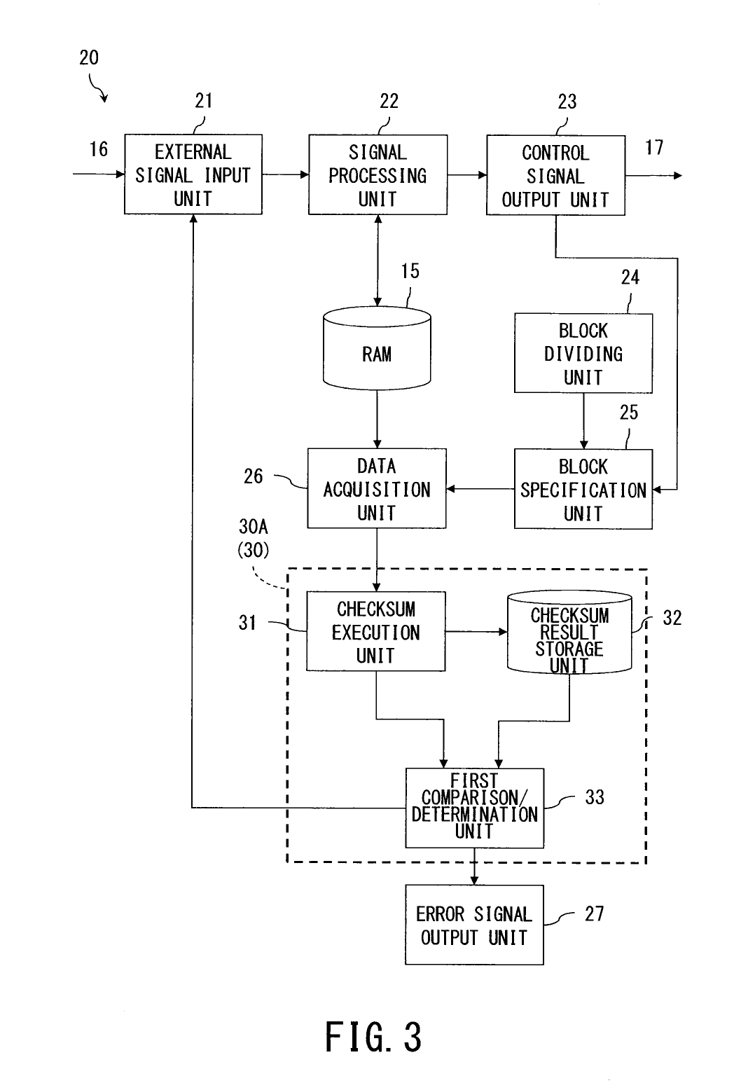

As shown in FIG. 3, the CPU 20 installed on the programmable control apparatus according to the first embodiment includes a signal processing unit 22 adapted to process inputted external signals 16 sequentially based on a program in the memory 15, a data acquisition unit 26 adapted to acquire data from a specified nth block of plural blocks obtained by dividing an area of the memory 15 (FIG. 2), a diagnostic unit 30A (30) adapted to diagnose health of the nth block based on the acquired data and then prompt a next external signal 16 to be processed, and a block specification unit 25 adapted to cause health of an (n+1)th block to be diagnosed after the next external signal 16 is processed.

The diagnostic unit 30A includes an execution unit 31 adapted to perform a checksum of data on a block by block basis, a storage unit 32 adapted to store a checksum result on each of the plural blocks, and a first comparison/determination unit 33 adapted to compare the results of the performed checksum with stored checksum results.

The signal processing unit 22 processes the external signals 16 based on the program in the memory 15 as the external signals 16 are inputted sequentially to an external signal input unit 21 from the input port 11 via the bus 13 (FIG. 1), and then outputs the control signals 17, which are produced as a result of the above process, from a control signal output unit 23 to the output port 12 via the bus 13 (FIG. 1).

The control signals 17 are intended to control external control equipment (not shown) and include, for example, a start signal for the entire engineered safety features, a start signal for pumps of the engineered safety features, and an open/close signal for several valves.

The external signal input unit 21 transfers the next external signal 16 to the signal processing unit 22 in synchronization with end timing of a health diagnostic process performed by the diagnostic unit 30. Then, the control signal output unit 23 makes the block specification unit 25 specify a block to be diagnosed next in synchronization with output timing of the control signals 17.

A block dividing unit 24 divides (N+1 divisions in FIG. 2) the fixed data storage area 15a (FIG. 2) to be checked in the first embodiment and assigns an identification number n (0≦n≦N, where n is an integer) to each block. Size of each block may be set as desired as long as the health diagnostics is finished within a time limit, and there is no need to divide the area into equal blocks. An address range of the fixed data storage area 15a can be divided properly if the size is expressed by an exponent of 2.

Each time a control signal 17 is outputted from the control signal output unit 23, the block specification unit 25 updates specification of the block whose health is diagnosed. That is, the block specification unit 25 specifies a 0th block just after startup of the programmable control apparatus 10 and updates the block specified to be diagnosed from the nth block to the (n+1)th block each time a process loop of one external signal 16 is repeated. Then, after the process loop is repeated and the Nth block is specified, the block specification unit 25 specifies the 0th block by returning to the start.

The block specification unit 25 is implemented as a program in the memory 15, and includes a block counter unit (not shown) adapted to store block numbers and a count-up unit (not shown) adapted to cause the block counter to count up.

In this case, when the CPU 20 starts up, the block counter unit sets the identification number of the block of the fixed data storage area 15a to n=0.

Then, each time the diagnostic unit 30 finishes processing and a next external signal 16 is inputted, the block identification number is incremented by one in the block counter unit. Then, when the block identification number is counted up to a total number N of the blocks to be diagnosed, the count is reset to 0.

The data acquisition unit 26 acquires data from the nth block specified by the block specification unit 25 out of the plural blocks (FIG. 2) obtained by dividing the area of the memory 15 and transfers the data to the diagnostic unit 30.

The diagnostic unit 30A, which is made up of the checksum execution unit 31, checksum result storage unit 32, and first comparison/determination unit 33, diagnoses the health of the nth block based on the data acquired from the nth block of the memory 15. Furthermore, when the health diagnostics is finished, the diagnostic unit 30A prompts the external signal input unit 21 to perform input processing of a next external signal 16.

For each block in the area of the memory 15, the checksum execution unit 31 performs a checksum on data acquired by the data acquisition unit 26. Note that the checksum itself is implemented by part of the program in the memory 15 and stored in the fixed data storage area 15a.

The checksum is a technique for detecting data errors. Specifically, a cyclic redundancy check (CRC) or a cryptographic hash function such as IETF MD5 or SHA of NIST (USA) can be used for calculation of the checksum. Use of a cryptographic hash function can increase resistance to malicious falsification.

Note that just after the CPU 20 starts up and program data is copied from the ROM 14 to the RAM (memory 15), the checksum execution unit 31 performs a checksum on all the blocks to be diagnosed in the fixed data storage area 15a of the memory 15.

The checksum results of all the blocks at the startup are stored in the storage unit 32 by being associated with the identification numbers of the corresponding respective blocks.

The first comparison/determination unit 33 is designed to compare a block's checksum result performed in synchronization with the control signals 17 outputted sequentially with the checksum result of the block stored in the checksum result storage unit 32.

If the comparison indicates that there is a match between the checksum results, the health of the block is verified and the external signal input unit 21 is prompted to input a next external signal 16.

On the other hand, if the comparison indicates that there is no match between the checksum results, the health of the block is denied and an error signal to that effect is outputted from an output unit 27.

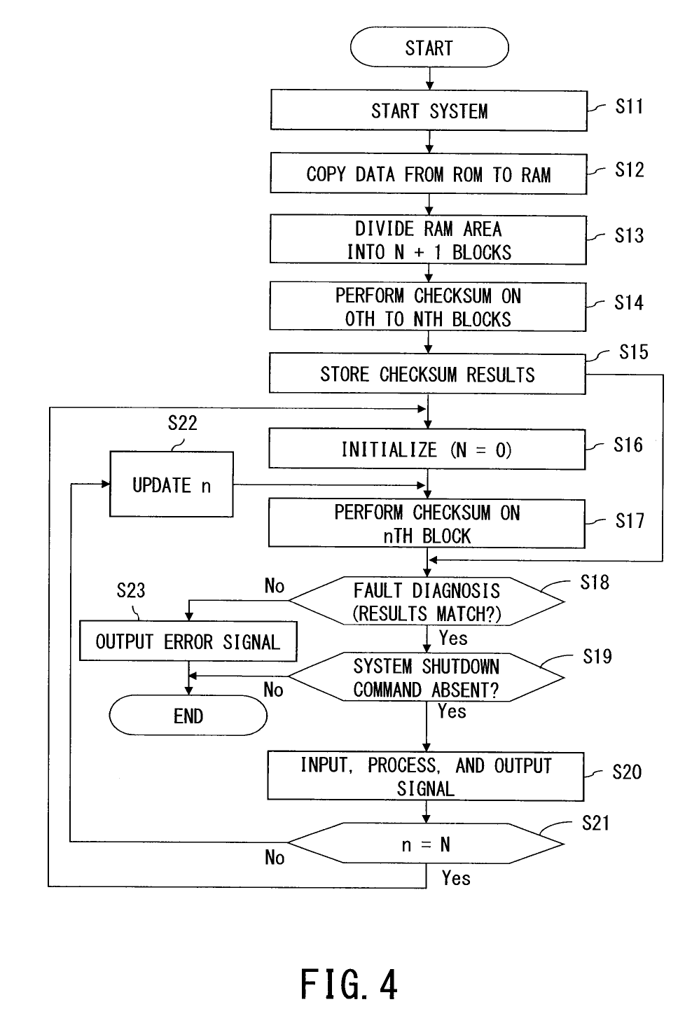

Operation of the programmable control apparatus according to the first embodiment will be described with reference to FIG. 4 (and to FIGS. 1 to 3 as required).

When a system of the programmable control apparatus 10 starts up (S11), programs and parameter data are copied from the ROM 14 to the RAM (memory 15) (S12). Subsequently, processing is performed according to the programs in the RAM (memory 15).

Furthermore, the fixed data storage area 15a of the RAM in which programs, data, and the like reside is conceptually divided into N+1 blocks: 0th block to Nth block (S13). A checksum is performed on all the 0th to Nth blocks (S14) and checksum results are stored in the checksum result storage unit 32 in such a way as to be retrievable by being associated with corresponding blocks (S15).

Once a control routine is started, the block identification number n is initialized (n=0) (S16) and the data which is resident in the 0th block and to be diagnosed is acquired and a checksum is performed on the data (S17). Then, results are compared between a checksum of the acquired resident data and the checksum performed on startup with the result being stored in the checksum result storage unit 32. If the results match (Yes in S18), the health of the 0th block is demonstrated, and the external signal 16 is inputted, processed, and outputted as a control signal 17 (S20).

Next, the block identification number is updated to n=1 (No in S21; S22), diagnosis of a 1st block is performed similarly, and a next external signal 16 is inputted, processed, and outputted (S17 to S20).

Then, when the block identification number is updated to n=N (Yes in S21), the identification number n is initialized (n=0) and diagnosis of the 0th to Nth blocks as well as input, processing, and output of the external signal 16 are repeated similarly (S16 to S20).

On the other hand, if the comparison of the checksums indicates that there is no match (No in S18), an error signal to that effect is outputted (S23) and the flow is finished. The flow is also finished when a system shutdown command is received from an operator or another system (No in S19).

A loop period of the control routine is determined to the extent of meeting requirements for system response. For example, if the time interval from when the programmable control apparatus 10 accepts input of an external signal 16 to when external control equipment (not shown) responds is required to be 1 sec. or less, the loop period needs to be 0.5 sec. or less.

In this way, in each embodiment, since a control routine is executed in a single loop, complex processes are not involved unlike in the case of a timer interrupt during multitasking, and thus reliability and safety of programs are ensured.

Furthermore, since the checksum performed in one single loop is targeted at 1/(N+1) of the memory area, the loop period can be adjusted so as to meet the requirements for system response by adjusting the number N of divisions as required.

Note that instead of judging the checksum results sequentially on individual ones of the N blocks outputted from the checksum execution unit 31, the first comparison/determination unit 33 may calculate a single checksum on all the N blocks by adding up checksums of the N individual blocks received in respective single loops, by performing predetermined logical calculations one after another, store the checksum in the checksum result storage unit 32, and judge the single checksum. In that case, the checksum result stored in the checksum result storage unit 32 only requires capacity for one checksum, making it possible to reduce memory capacity.

### Second Embodiment

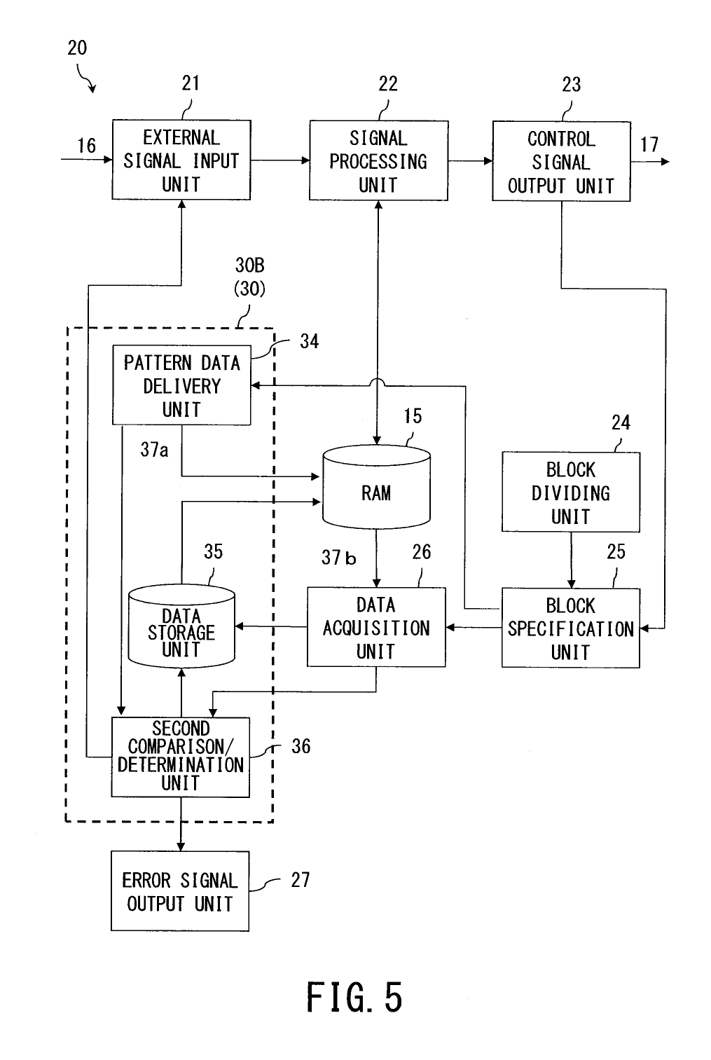

As shown in FIG. 5, a CPU 20 installed on a programmable control apparatus according to a second embodiment includes a signal processing unit 22 adapted to process inputted external signals 16 sequentially based on a program in a memory 15, a data acquisition unit 26 adapted to acquire data from a specified nth block of plural blocks obtained by dividing an area of the memory 15 (FIG. 2), a diagnostic unit 30B (30) adapted to diagnose health of the nth block based on the acquired data and then prompt a next external signal 16 to be processed, and a block specification unit 25 adapted to cause heath of an (n+1)th block to be diagnosed after the next external signal 16 is processed.

In FIG. 5, components same as or equivalent to those in FIG. 3 are denoted by the same reference numerals as the corresponding components in FIG. 3, and redundant description thereof will be omitted.

A block dividing unit 24 divides a variable data storage area 15b (FIG. 2) to be checked in the second embodiment and assigns an identification number n (0≦n≦N) to each block.

The diagnostic unit 30B includes a delivery unit 34 adapted to send out pattern data 37a to a specified nth block, a second comparison/determination unit 36 adapted to compare pattern data 37b acquired from the specified nth block with the pattern data 37a sent out, and a storage unit 35 adapted to temporarily save data of the specified nth block and return the data after the comparison.

The diagnostic unit 30B acquires the known pattern data 37a by storing the pattern data 37a once in the nth block of the memory 15, and diagnoses health of the nth block based on whether or not there is a match. Furthermore, when the health diagnostics is finished, the diagnostic unit 30B prompts the external signal input unit 21 to perform input processing of a next external signal 16.

The pattern data delivery unit 34 is designed to send out the pattern data 37a to the nth block in the RAM specified by the block specification unit 25. Here, the pattern data 37a is configured such that if each block is made up, for example, of 8 bits, the bits in the block are arranged in a pattern such as 00000000, 11111111, 01010101, or 10101010.

The data storage unit 35 is implemented as one block in the variable data storage area 15b of the memory and used to temporarily save the data resident in the nth block before the pattern data 37a is sent out to the specified nth block.

Furthermore, the storage unit 35 holds the saved resident data until diagnosis of the nth block is finished, and returns the data to the nth block again after the end of the diagnosis.

The second comparison/determination unit 36 is designed to compare the pattern data 37a sent out to the nth block with the pattern data 37b acquired after recording in the nth block, where the pattern data 37a is sent out in synchronization with the control signals 17 outputted sequentially.

Note that the pattern data 37a sent out is not limited to one type and that multiple types may be sent out to a block, followed by multiple comparisons.

Then, if a result of the comparison indicates that there is a match between the two sets of pattern data 37a and 37b, the health of the block is verified and the external signal input unit 21 is prompted to input a next external signal 16.

On the other hand, if the result of comparison indicates that there is no match between the two sets of pattern data 37a and 37b, the health of the block is denied and an error signal to that effect is outputted from an output unit 27.

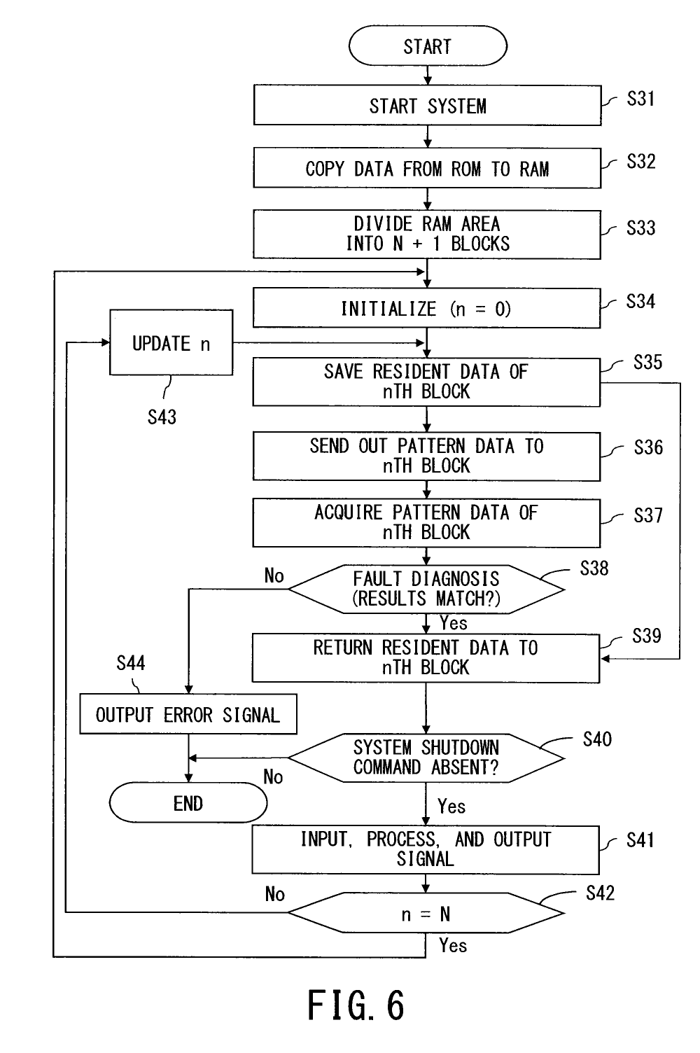

Operation of the programmable control apparatus according to the second embodiment will be described with reference to FIG. 6 (and see FIGS. 1 to 5 as required).

When a system of the programmable control apparatus 10 starts up (S31), programs and parameter data are copied from the ROM 14 to the RAM (memory 15) (S32). Subsequently, processing is performed according to the programs in the RAM (memory 15).

Furthermore, the variable data storage area 15b of the RAM in which programs, data, and the like reside is conceptually divided into N+1 blocks: 0th block to Nth block (S33).

Once a control routine is started, the block identification number n is initialized (n=0) (S34) and the data which is resident in the 0th block and to be diagnosed is saved in the storage unit 35 (S35).

Next, the pattern data 37a is sent out to the 0th block (S36), and then the pattern data 37b recorded in the 0th block is acquired (S37). Then, the pattern data 37a sent out and the pattern data 37b acquired after recording are compared with each other (S38). If there is a match between the two sets of data (Yes in S38), the health of the 0th block is demonstrated, the resident data saved in the storage unit 35 is returned to the 0th block (S39), and the external signal 16 is inputted, processed, and outputted as a control signal 17 (S41).

Next, the block identification number is updated to n=1 (No in S42; S43), diagnosis of the 1st block is performed similarly, and a next external signal 16 is inputted, processed, and outputted (S35 to S41).

Then, when the block identification number is updated to n=N (Yes in S42), the identification number n is initialized (n=0) and diagnosis of the 0th to Nth blocks as well as input, processing, and output of the external signal 16 are repeated similarly (S34 to S41).

On the other hand, if the comparison indicates that there is no match between the pattern data before and after recording (No in S38) in the block, an error signal to that effect is outputted (S44) and the flow is finished. The flow is also finished when a system shutdown command is received from an operator or another system (No in S40).

### Third Embodiment

A diagnostic unit (not shown) of a programmable control apparatus according to a third embodiment combines the diagnostic unit 30A (FIG. 3) of the first embodiment and the diagnostic unit 30B (FIG. 5) of the second embodiment.

A checksum result of the resident data in the nth block before recording of the pattern data 37a is compared with a checksum result of the resident data in the nth block returned after being temporarily saved in the data storage unit 35.

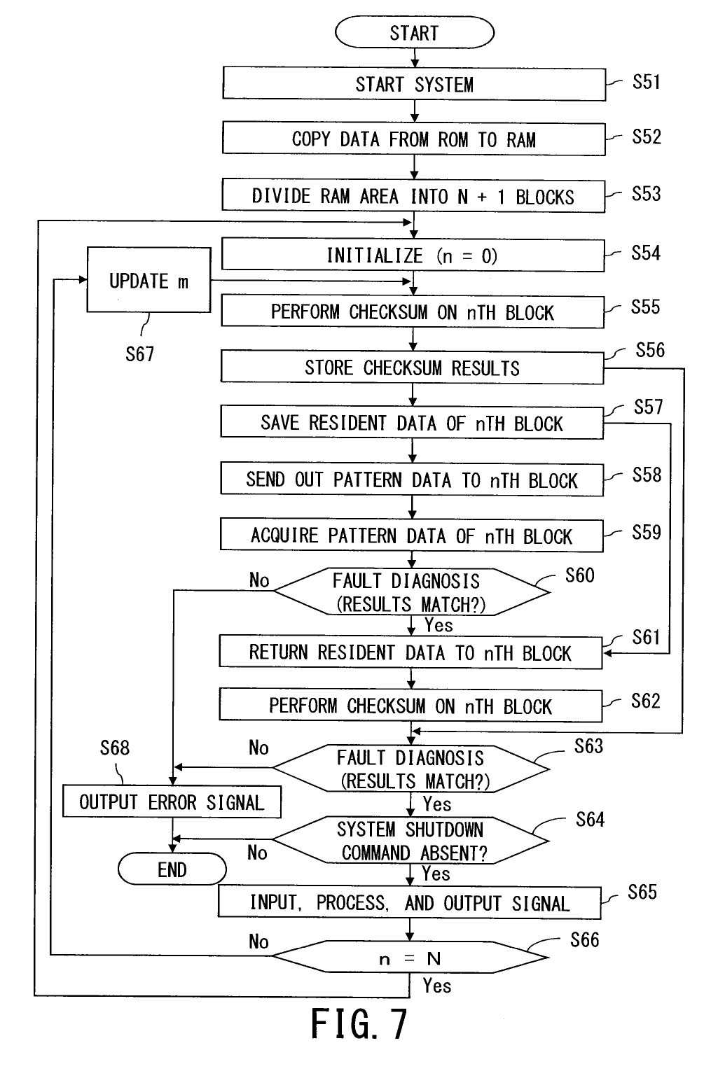

Operation of the programmable control apparatus according to the third embodiment will be described with reference to FIG. 7.

When a system of the programmable control apparatus 10 starts up (S51), programs and parameter data are copied from the ROM 14 to the RAM (memory 15) (S52). Subsequently, processing is performed according to the programs in the RAM (memory 15).

Furthermore, the variable data storage area 15b of the RAM in which programs, data, and the like reside is conceptually divided into N+1 blocks: 0th block to Nth block (S53).

A control routine is started, the block identification number n is initialized (n=0) (S54) and the data which is resident in the 0th block and to be diagnosed is acquired and a checksum is performed on the data (S55). Then, a checksum result is stored in the checksum result storage unit 32 in such a way as to be retrievable by being associated with corresponding blocks (S56).

Next, the data which is resident in the 0th block is saved in the storage unit 35 (S57) and the pattern data 37a is sent out to the 0th block next (S58). Then, the pattern data 37b recorded in the 0th block is acquired (S59) and the pattern data 37a sent out and the pattern data 37b acquired after recording are compared with each other (S60). If there is a match between the two sets of data (Yes in S60), the resident data saved in the storage unit 35 is returned to the 0th block (S61).

Next, a checksum is performed by calling the returned resident data of the 0th block (S62). Then, a checksum result of the resident data after the return is compared with the checksum result stored in the checksum result storage unit 32, and if there is a match between the results (Yes in S63), the health of the 0th block is demonstrated and the external signal 16 is inputted, processed, and outputted as a control signal 17 (S65).

Next, the block identification number is updated to n=1 (No in S66; S67), diagnosis of the 1st block is performed similarly, and a next external signal 16 is inputted, processed, and outputted (S55 to S65).

Then, when the block identification number is updated to n=N (Yes in S66), the block identification number n is initialized (n=0) and diagnosis of the 0th to Nth blocks as well as input, processing, and output of the external signal 16 are repeated similarly (S54 to S65).

On the other hand, if the comparison of the pattern data indicates that there is no match (No in S60) or the comparison of the checksum results indicates that there is no match (No in S63), an error signal to that effect is outputted (S68) and the flow is finished. The flow is also finished when a system shutdown command is received from an operator or another system (No in S64).

The programmable control apparatus according to at least one of the embodiments described above conceptually divides the memory in which programs reside into blocks and performs health diagnostics on a block by block basis, diagnosing one block each time a control loop makes a circuit. In this way, by performing health diagnostics of the memory in a scattered manner, it is possible to ensure reliability and safety of a plant without extending the period of the control loop.

Whereas a few embodiments of the present invention have been described, these embodiments are presented only by way of example, and not intended to limit the scope of the invention. These embodiments can be implemented in various other forms, and various omissions, replacements, and changes can be made without departing from the spirit of the invention. Such embodiments and modifications thereof are included in the spirit and scope of the invention as well as in the invention set forth in the appended claims and the scope of equivalents thereof.

1. A programmable control apparatus comprising:
a signal processing unit configured to sequentially process inputted external signals based on a program in a memory;
a data acquisition unit configured to acquire data from a specified nth block of a plurality of blocks obtained by dividing an area of the memory;
a diagnostic unit configured to diagnose health of the nth block based on the acquired data and then prompt a next external signal to be processed; and
a block specification unit configured to cause health of an (n+1)th block to be diagnosed after the next external signal is processed.

2. The programmable control apparatus according to claim 1, wherein the diagnostic unit includes:
an execution unit configured to perform a checksum of data on a block by block basis;
a storage unit configured to store a checksum result on each of the plurality of blocks; and
a first comparison/determination unit configured to compare the results of the performed checksum with the stored checksum results.

3. The programmable control apparatus according to claim 1, wherein the diagnostic unit includes:
a delivery unit configured to send out pattern data to the specified nth block;
a second comparison/determination unit configured to compare the pattern data acquired from the specified nth block with the pattern data sent out; and
a storage unit configured to temporarily save data of the specified nth block and return the data after the comparison.

4. The programmable control apparatus according to claim 3, wherein the diagnostic unit
compares a checksum result of data in the nth block before recording of the pattern data with a checksum result of the data in the nth block returned after being saved temporarily.

5. A programmable control method comprising:
a step of sequentially processing inputted external signals based on a program in a memory;
a step of acquiring data from a specified nth block of a plurality of blocks obtained by dividing an area of the memory;
a step of diagnosing health of the nth block based on the acquired data and then prompting a next external signal to be processed; and
a step of causing health of an (n+1)th block to be diagnosed after the next external signal is processed.

6. A programmable control program configured to cause a computer to carry out:
a step of sequentially processing inputted external signals based on a program in a memory;
a step of acquiring data from a specified nth block of a plurality of blocks obtained by dividing an area of the memory;
a step of diagnosing health of the nth block based on the acquired data and then prompting a next external signal to be processed; and
a step of causing health of an (n+1)th block to be diagnosed after the next external signal is processed.
